(19) United States
(12) Patent Application Publication
(10) Pub. No.: US 2020/0318780 A1
(43) Pub. Date: Oct. 8, 2020

(54) MOUNTING DEVICE

(71) Applicant: IZUMI-COSMO COMPANY, LIMITED, Osaka (JP)

(72) Inventors: Teruyuki ABE, Tokyo (JP); Shuhei KAMEDA, Tokyo (JP); Tomoya MORITA, Tokyo (JP); Kazuharu SEKI, Tokyo (JP)

(21) Appl. No.: 16/305,737

(22) PCT Filed: May 31, 2017
(86) PCT No.: PCT/JP2017/020232

§ 371 Date: Nov. 29, 2018

(30) Foreign Application Priority Data
Jun. 1, 2016 (JP) 2016-110319

(51) Int. Cl. F16M 11/38; F16M 11/42

(52) U.S. Cl. CPC F16M 11/38; F16M 2200/063; F16M 11/42

(57) ABSTRACT

In order to provide a mounting device in which a projection range of an image from a projector or the like can be expanded and the image can be projected in a stable state, there is provided a mounting device, comprising: a mounting part, the mounting part serving to mount a projectable object to be mounted; a pivotal part, the pivotal part being connected with the mounting part and allowing the mounting part to be pivoted; an elevating part, the elevating part being connected with the pivotal part and allowing a height level of the mounting part to be changed; and a base part, the base part serving to locate the elevating part, wherein the pivotal part is configured to be pivotable in a horizontal direction or a vertical direction about an axis rotatably configured, wherein the elevating part comprises a supporting portion, a fixed portion on the base part, a piston, and at least one coupling portion, the supporting portion serving to support the pivotal part, the piston connecting the supporting portion with the fixed portion, the coupling portion coupling the supporting portion with the fixed portion, and wherein the coupling portion is configured to be capable of making a displacement of the coupling portion.

### TECHNICAL FIELD

The disclosure relates to a mounting device. Particularly, the disclosure relates to a mounting device for mounting an object to be mounted such as a projector.

### BACKGROUND OF THE INVENTION

A projection of an image onto a screen has been conventionally performed by using a projector or the like. The projector or the like may be used after a mounting thereof on an angle adjustment device disclosed in Patent Document 1, for example. The angle adjustment device includes a support part, a mounting part for placing a projector or the like, and an angle setting mechanism, the mounting part being supported by the supporting portion and being adjusted and fixed at a predetermined height position, the angle setting mechanism being capable of inclining the mounting part from a horizontal position to a position inclined by 30 degrees. The support part includes a support tube and a movable tube configured to be movable up and down in the support tube. A knob handle for fixing the movable tube is screwed in an upper end of the support tube.

### PATENT DOCUMENTS (RELATED ART PATENT DOCUMENTS)

PATENT DOCUMENT 1: Japanese Unexamined Patent Application Publication No. 2005-121918

### DISCLOSURE OF THE INVENTION

### Problems to be Solved by the Invention

However, in a case of a use of the angle adjustment device disclosed in Patent Document 1, the following problem may arise.

Specifically, Patent Document 1 discloses that the angle adjustment device allows the mounting part to be inclined from a horizontal position to a position inclined by 30 degrees. Thus, the image may not be properly projected from the projector or the like on the angle adjustment device unless the screen is located on a substantial vertical plane. Namely, a projection range of the image from the projector or the like mounted on the mounting part is limited.

Furthermore, Patent Document 1 discloses that the movable tube is moved up and down and then the movable tube moved up and down is fixed at the predetermined position using the knob handle at the upper end of the support tube to fix the support part at the predetermined height position. Namely, the support tube and the movable tube are fixed by only the knob handle at the upper end of the support tube. Thus, the number of a connection point between the support tube and the movable tube is substantially one. Thus, a connection-strength between the support tube and the movable tube is not sufficient, which makes a stability-maintenance of the support part impossible. As a result, the image from the projector or the like mounted on the support part may not be projected in a stable state.

Under these circumstances, the present invention has been created. That is, an object of the present invention is to provide a mounting device in which a projection range of an image from a projector or the like can be expanded and the image can be projected in a stable state.

### Means for Solving the Problems

In order to achieve the above object, an embodiment of the present invention provides a mounting device, comprising:
a mounting part, the mounting part serving to mount a projectable object to be mounted;
a pivotal part, the pivotal part being connected with the mounting part and allowing the mounting part to be pivoted;
an elevating part, the elevating part being connected with the pivotal part and allowing a height level of the mounting part to be changed; and
a base part, the base part serving to locate the elevating part,
wherein the pivotal part is configured to be pivotable in a horizontal direction or a vertical direction about an axis rotatably configured,
wherein the elevating part comprises a supporting portion, a fixed portion on the base part, a piston, and at least one coupling portion, the supporting portion serving to support the pivotal part, the piston connecting the supporting portion with the fixed portion, the coupling portion coupling the supporting portion with the fixed portion, and
wherein the coupling portion is configured to be capable of making a displacement of the coupling portion.

In a preferable aspect, the coupling portion is configured such that one of ends of the coupling portion is coupled with the supporting portion and other of ends of the coupling portion is coupled with the fixed portion.

In a preferable aspect, a downward displacement of the coupling portion is performed in accordance with a downward displacement of the supporting portion.

In a preferable aspect, an upward displacement of the coupling portion is performed in accordance with an upward displacement of the supporting portion.

In a preferable aspect, the mounting device further comprises a handle part, the handle part being located to surround the object to be mounted.

In a preferable aspect, the base part is configured to be movable.

### Effect of the Invention

In a mounting device according to an embodiment of the present invention, the pivotal part is configured to be pivotable in a horizontal direction or a vertical direction about an axis rotatably configured. Thus, a mounting part connected with the pivotal part can be also pivoted in the horizontal direction or the vertical direction with a movement of the pivotal part. Thus, an object to be mounted on the mounting part can be also pivoted in the horizontal direction or the vertical direction with a movement of the mounting part. As a result, it is possible to expand a projection range of an image from a projectable object to be mounted.

In a mounting device according to an embodiment of the present invention, an elevating part comprises at least one coupling portion for coupling a supporting portion with a fixed portion, the supporting portion serving to support the pivotal part, the fixed portion being located on a base part. Since the supporting portion and the fixed portion are connected with each other via the coupling portion, the elevating part can have at least two connection points. Thus, it is possible to improve a connection-strength of the elevating part, and thus a mounting stability of the object to be mounted on the mounting part can be improved. As a result, the image can be projected in a stable state from the projectable object to be mounted.

### BRIEF DESCRIPTION OF THE DRAWINGS

FIG. 1 is a cross-sectional view schematically showing amounting device according to a first embodiment of the present invention.

FIG. 2 is a cross-sectional view schematically showing a mounting device according to a second embodiment of the present invention.

FIG. 3 is a cross-sectional view schematically showing amounting device according to a third embodiment of the present invention.

### MODES FOR CARRYING OUT THE INVENTION

Hereinafter, a mounting device according to an embodiment of the present invention will be described with reference to drawings.

### Technical Idea of Present Invention

The inventors of the present application have intensively considered a solution in which a projection range of an image from a projector or the like can be expanded and the image can be projected in a stable state. As a result, the inventors of the present application have created a mounting device of the present invention. In order to realize the solution, the present invention has a technical idea that a mounting device having following configurations is provided, the configurations serving to (1) pivote a projectable object to be mounted such as a projector in a horizontal direction or a vertical direction and to (2) improve a connection-strength in an elevating part for changing a height of a mounting part. According to the technical idea, it is possible to suitably project the image from the projectable object such as the projector onto a screen or the like arranged on a vertical plane or a horizontal plane. Furthermore, according to the technical idea, the connection strength of the elevating part can be improved, which allows an improvement of the mounting stability of the object to be mounted onto the mounting part. Therefore, it is possible to project the image from the projectable object to be mounted in a stable state.

Hereinafter, a configuration of the present invention for realizing the above technical idea will be specifically described.

### First Embodiment

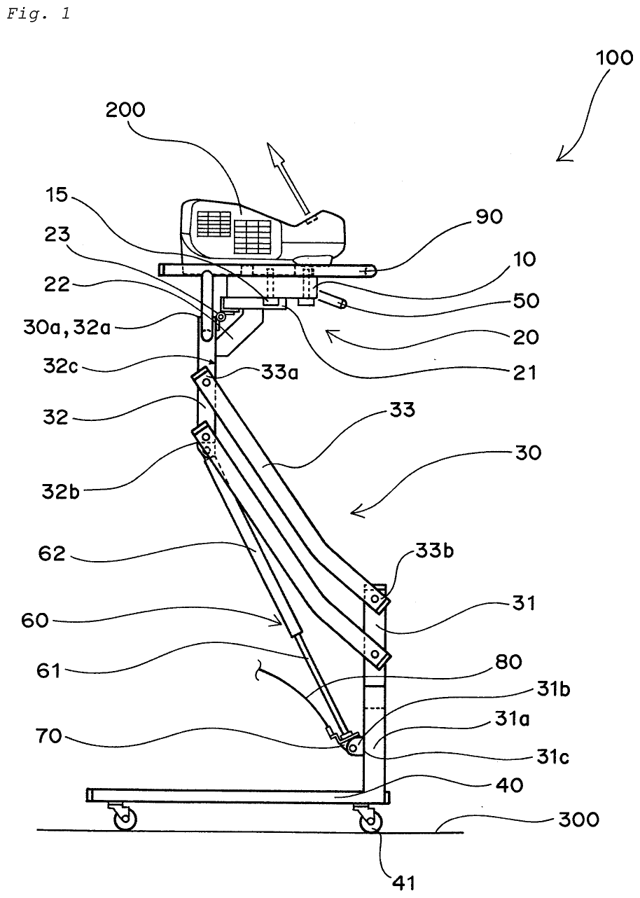

Installation direction of mounting part: Horizontal direction Installation height of mounting part: Relatively high
Firstly, a mounting device according to a first embodiment of the present invention will be described with reference to FIG. 1. FIG. 1 is a cross-sectional view schematically showing a mounting device according to a first embodiment of the present invention.

As shown in FIG. 1, a mounting device 100 according to a first embodiment of the present invention includes a mounting part 10, a pivotal part 20, an elevating part 30 or a lifting part, and a base part 40.

The mounting part 10 serves to mount the projectable object to be mounted 200. The projectable object to be mounted 200 includes a projector for example.

The pivotal part 20 is connected with the mounting part 10. The pivotal part 20 includes a receiving portion 21 for receiving the mounting part 10, an abutting portion 22 provided on a lower surface of the receiving portion 21, and an axis rotatably configured 23 (or an axis rotatably supported).

The pivotal part 20 is configured to be pivotable about the axis rotatably configured 23. A detail description will be as follows.

The elevating part 30 is connected with the pivotal part 20 such that the axis rotatably configured 23 is positioned at an upper end 30a of the elevating part 30. The elevating part 30 includes a fixed portion 31, a supporting portion 32, and at least one coupling portion 33 for coupling the fixed portion 31 with the supporting portion 32. The fixed portion 31 of the elevating part 30 is fixedly arranged on the base part 40 positioned to be in a contact with a ground 300. As an example, the fixed portion 31 is positioned on the base part 40 to extend in a direction substantially upwardly vertical to an extension direction of the base part 40. The supporting portion 32 of the elevating part 30 supports the pivotal part 20 such that the axis rotatably configured 23 of the pivotal part 20 is positioned at an upper end 32a of the supporting portion 32. Furthermore, the base part 40 may be also movable such that the mounting device 100 is movable from one location to another location. To obtain the movable base part 40, the base part 40 may include wheels 41 at a portion where the base part contacts the ground 300. In such a case, the base part 40 plays a role of a moving mechanism.

As shown in FIG. 1, a protrusion 31b of the fixed portion 31 and a lower end 32b of the supporting portion 32 are connected via a cylinder member 60 with each other, the protrusion 31b of the fixed portion 31 being provided in an inner region 31c of a lower portion 31a of the fixed portion 31 in a cross-sectional view or side view. The cylinder member 60 includes a pipe 61 and a cylinder 62. The cylinder 62 is slidable to encompass a forming surface of the pipe 61 and has a gas spring function. An end of the pipe 61 of the cylinder member 60 is connected with an angle changeable portion 70 arranged pivotably at the protrusion 31 b of the fixed portion 31. The angle changeable portion 70 is connected to the one of ends of a tube 80, and the other of the ends of the tube 80 is connected with a lever part 50.

In the first embodiment, in a state that the lever part 50 is not pulled, the cylinder 62 of the cylinder member 60 maintains a steady state without sliding such that the cylinder 62 encompasses the pipe 61 of the cylinder member, the pipe 61 being connected with the angle changeable portion 70. The pipe 61 is configured to be inserted from one side of the cylinder 62 into the cylinder 62 and also to be slidable from the one of sides to the other of sides of the cylinder 62. Specifically, in the first embodiment, a degree of an insertion of the pipe 61 into the cylinder 62 is relatively small as shown in FIG. 1. More specifically, in a case that a degree of an insertion of the pipe 61 is relatively small, a distance between the protrusion 31b of the fixed portion 31 and the lower end 32b of the supporting portion 32 is relatively larger than a longitudinal dimension of the cylinder 62. As a result, the supporting portion 32 may be positioned above the fixed portion 31.

In such a case, the coupling portion 33 is configured to couple the fixed portion 31 with the supporting portion 32 above the fixed portion. Thus, one of ends 33a of the coupling portion 33 is positioned above other of ends 33b of the coupling portion 33, the one of the ends 33a of the coupling portion 33 being coupled with the supporting portion 32, the other of the ends 33b of the coupling portion 33 being coupled with the fixed portion 31. The supporting portion 32 of the elevating part 30 is in a connection with the mounting part 10 via the pivotal part 20. Thus, the supporting portion 32 at an upper side position causes the mounting part 10 to be positioned at an upper side position. As a result, the above position of the mounting part 10 makes a height level of the mounting part 10 relatively higher in the first embodiment. Therefore, a height level of the object 200 mounted on the mounting part 10 is made relatively higher.

Further, the pivotal part 20 is configured to be pivotable about an axis rotatably configured 23.

Specifically, in the first embodiment, the pivotal part 20 is configured such that the abutting portion 22 of the pivotal part 20 abuts or contacts an inner side surface 32c of the supporting portion 32 of the elevating part 30. In the present invention, when the abutting portion 22 abuts the inner side surface 32c of the supporting portion 32, the receiving portion 21 of the pivotal part 20 is configured to be positioned in a horizontal direction. The abutment of the abutting portion 22 with the inner side surface 32c of the supporting portion 32 prevents the abutting portion 22 from advancing further in an installation direction of the supporting portion 32.

Therefore, a movement of the abutting portion 22 is fixed, and thus the receiving portion 21 of the pivotal part 20 can be fixed in the horizontal direction. The fixing of the receiving portion 21 of the pivotal part 20 in the horizontal direction allows the mounting part 10 to be fixed in the horizontal direction, the mounting part 10 being received on the receiving portion 21 of the pivotal part 20. Due to the fixing of the mounting part 10 in the horizontal direction, the projectable object 200 to be mounted on the mounting part 10 can be fixed in the horizontal direction. As a result, the object to be mounted 200 allows a projection of the image in an arrow direction in FIG. 1, the arrow direction corresponding to an obliquely upward direction for example. Therefore, it is possible to suitably project the image from the projectable object to be mounted 200 onto a screen or the like arranged on the vertical plane.

### Second Embodiment

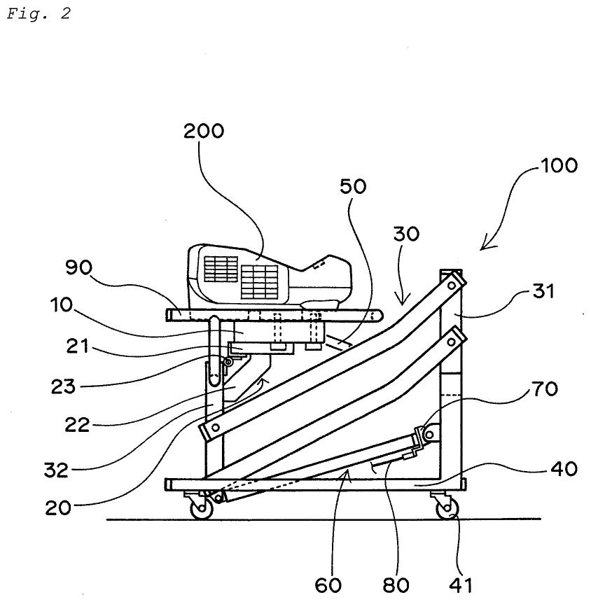

Installation direction of mounting part: Horizontal direction Installation height of mounting part: Relatively low
Next, a mounting device according to a second embodiment of the present invention will be described with reference to FIG. 2. FIG. 2 is a cross-sectional view schematically showing a mounting device according to a second embodiment of the present invention.

The second embodiment is characterized in that a height level of the mounting part 10 in the second embodiment is different from that of the mounting part 10 in the first embodiment.

In the second embodiment, by a pull of the lever part 50, the height level of the mounting part 10 is lowered than that of the mounting part 10 in the first embodiment. Hereinafter, a principle for lowering the height level of the mounting part 10 will be described.

The pull of the lever part 50 causes a tube 80 connected with the lever part 50 to be in a tension state. As a result, the tension of tube 80 causes the angle changeable portion 70 to be pivoted, and/or causes a load force of the object to be mounted 200 on the mounting part 10 to function in a gravity direction. Thus, the cylinder 62 is slided in one direction with a gas compression such that the cylinder 62 encompasses the pipe 61 of the cylinder member 60. Specifically, in the second embodiment, a degree of an insertion of the pipe 61 into the cylinder 62 is relatively large as shown in FIG. 2. More specifically, in a case that a degree of an insertion of the pipe 61 is relatively large, a distance between the protrusion 31b of the fixed portion 31 and the lower end 32b of the supporting portion 32 approaches the longitudinal dimension of the cylinder 62. Thus, a force for pulling the supporting portion 32 downwardly is applied via the lower end 32b of the supporting portion 32 connected with the cylinder member 60, which causes the supporting portion 32 to be displaced downwardly. Finally, when the pipe 61 is fully inserted into the cylinder 62 with the gas compression, the supporting portion 32 can be positioned to substantially face the fixed portion 31 as shown in FIG. 2.

The coupling portion 33 connects the fixed portion 31 with the supporting portion 32, and thus a downward displacement of the coupling portion 33 is performed in accordance with a downward displacement of the supporting portion 33. The supporting portion 32 of the elevating part 30 is connected with the mounting part 10 via the pivotal part 20. Thus, the mounting part 10 is also displaced downwardly in accordance with the downward displacement of the supporting portion 32. Therefore, the height level of the mounting part 10 in the second embodiment is lowered than that of mounting part 10 in the first embodiment, and thus the height level of the object 200 mounted on the mounting part 10 is also lowered.

When the pull state of the lever part 50 is released, the tension state of the tube 80 connected with the lever part 50 is also released. Due to the release of the tension state of the tube, the cylinder 62 slides on the pipe 61 of the cylinder member 60 in a direction opposite to the one direction as described above with a release of the gas compression. Specifically, due to release of the tension state of the tube 80, the degree of the insertion of the pipe 61 into the cylinder 62 is relatively lowered. More specifically, in a case that a degree of an insertion of the pipe 61 is relatively low, a distance between the protrusion 31b of the fixed portion 31 and the lower end 32b of the supporting portion 32 is relatively longer than the longitudinal dimension of the cylinder 62. Thus, a force for pulling the supporting portion 32 upwardly is applied via the lower end 32b of the supporting portion 32 connected with the cylinder member 60, which causes the supporting portion 32 to be displaced upwardly. Finally, due to the upward displacement of the supporting portion 32, the supporting portion 32 can be positioned at a predetermined portion above the fixed portion 31 as shown in FIG. 1.

The coupling portion 33 connects the fixed portion with the supporting portion 32, and thus an upward displacement of the coupling portion 33 is performed in accordance with the upward displacement of the supporting portion 33. The supporting portion 32 of the elevating part 30 is connected with the mounting part 10 via the pivotal part 20. Thus, the mounting part 10 is also displaced upwardly in accordance with the upward displacement of the supporting portion 32. Therefore, the height level of the mounting part 10 is made higher than that of mounting part 10 in the second embodiment, and thus the height level of the object 200 mounted on the mounting part 10 is also made higher.

### Third Embodiment

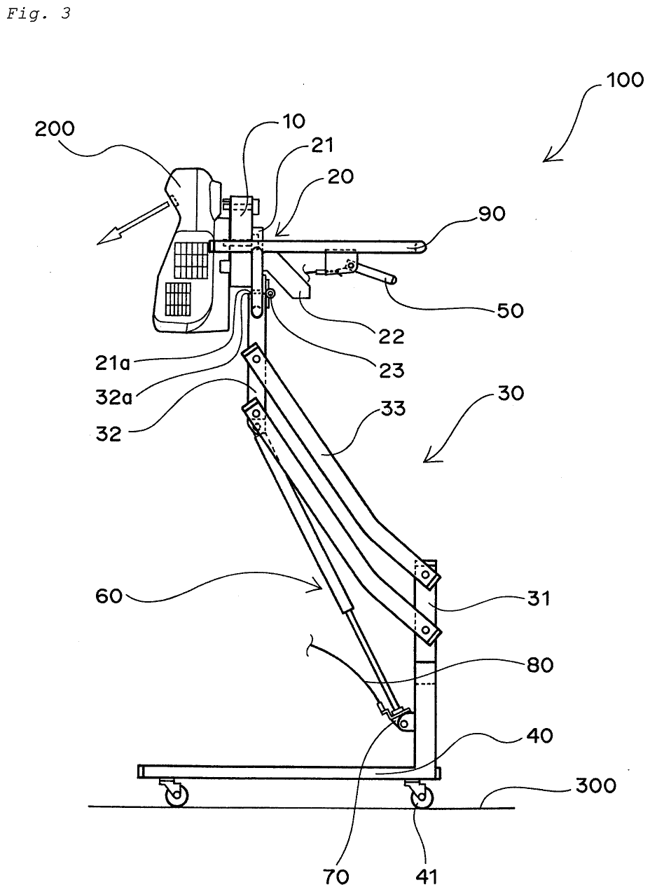

Installation direction of mounting part: Vertical direction Installation height of mounting part: Relatively high
Next, a mounting device according to a third embodiment of the present invention will be described with reference to FIG. 3. FIG. 3 is a cross-sectional view schematically showing a mounting device according to a third embodiment of the present invention.

The third embodiment is characterized in that a position of the pivotal part 20 in the third embodiment is different from that of the pivotal part 20 in the first embodiment.

Specifically, in the third embodiment, the pivotal part 20 is pivoted such that an edge surface 21a of receiving portion 21 of the pivotal part 20 abuts the upper end 32a of the supporting portion 32 of the elevating part 30. In the present invention, when the edge surface 21a of the receiving portion 21 abuts the upper end 32a of the supporting portion 32 of the elevating part 30, the receiving portion 21 of the pivotal part 20 is configured to be positioned in a vertical direction. The abutment of the edge surface 21a of the receiving portion 21 with the upper end 32a of the supporting portion 32 of the elevating part 30 prevents the edge surface 21a of the receiving portion 21 from advancing further in an installation direction of the supporting portion 32.

Therefore, a movement of the receiving portion 21 is fixed, and thus the receiving portion 21 of the pivotal part 20 can be fixed in the vertical direction. The fixing of the receiving portion 21 of the pivotal part 20 in the vertical direction allows the mounting part 10 to be fixed in the vertical direction, the mounting part 10 being received on the receiving portion 21 of the pivotal part 20. Due to the fixing of the mounting part 10 in the vertical direction, the projectable object 200 to be mounted on the mounting part 10 can be fixed in the vertical direction. As a result, the object to be mounted 200 allows a projection of the image in an arrow direction in FIG. 3, the arrow direction corresponding to an obliquely downward direction for example. Therefore, it is possible to project the image from the projectable object to be mounted 200 onto an object to be projected, the object to be projected being arranged on the horizontal plane.

As described in the above first embodiment and the third embodiment, the pivotal part 20 is configured to be pivotable in the horizontal direction or the vertical direction about the axis rotatably configured 23. Due to the pivot of the pivotal part 20 in the horizontal direction or the vertical direction, the mounting part 10 connected with the pivotal part 20 can be also pivoted in the horizontal direction or the vertical direction with the movement of the pivotal part 20 in the present invention. Thus, the object to be mounted 200 on the mounting part 10 can be also pivoted in the horizontal direction or the vertical direction with the movement of the mounting part 10. As a result, it is possible to project the image from the projectable object to be mounted 200 onto the object to be projected, the object to be projected being arranged on the horizontal plane or the vertical plane. Namely, it is possible to expand the projection range of the image from the projectable object to be mounted 200.

As described above, the elevating part 30 includes at least one coupling portion 33 for coupling the supporting portion 32 with the fixed portion 31, the supporting portion 32 serving to support the pivotal part 20, the fixed portion 31 being located on the base part 40. Since the supporting portion 32 and the fixed portion 31 are connected with each other via the coupling portion 33, the elevating part 30 has at least two connection points. Thus, it is possible to improve the connection-strength of the elevating part, and thus the mounting stability of the object to be mounted 200 on the mounting part 10 can be improved. As a result, the image can be projected in the stable state from the projectable object to be mounted 200. Furthermore, in accordance with the skilled person's general knowledge, a height adjustment portion as a composition element of a conventional mounting device is composed of a support tube and a movable tube configured to be movable up and down in the support tube to promptly move a position of the object to be projected up and down, the height adjustment portion functionally corresponding to the elevating part in the present invention. Namely, it is general for the skilled person to consider a rapid up-and-down movement of a position of the object to be mounted as to the mounting device. On the other hand, the present invention focuses on the projection of the image in the stable state from the projectable object to be mounted. As a result, a configuration of the elevating part 30 in the mounting device has been created in the present invention. In this respect, the present invention has a viewpoint different from that of the conventional mounting device with respect to the height adjustment portion, the height adjustment portion functionally corresponding to the elevating part in the present invention.

The present invention may adopt the following embodiments.

Specifically, the mounting device 100 of the present invention may further include a handle part as shown in FIGS. 1-3, the handle part being located to surround the object to be mounted 200. The projectable object to be mounted 200 such as the projector is a so-called “precision instrument”. Since the projectable object to be mounted is the “precision instrument”, it is desirable to avoid a contact of the projectable object to be mounted with an exterior portion. Due to a location of the handle part 90 which serves to surround the object to be mounted 200, the handle part 90 can be used not only for a push-pull of the handle part 90 such that an user can move the mounting device 100 from one place to another place, but also for a protection of the object to be mounted 200 which is the “precision instrument”.

Furthermore, as shown in FIG. 1, the mounting part 10 and the object to be mounted 200 may be connected via a connection part 15 such as a screw part. In this regard, due to a suitable adjustment of a degree of a connection by the connection part 15, a fine adjustment for an installation position of the object 200 after a mounting thereof on the mounting part 10 may be performed. This makes it possible to suitably perform the fine adjustment of the projection position of the image from the object to be mounted 200 to the object to be projected such as the screen.

In the above description, an embodiment wherein the mounting device includes the pivotal part has been shown. Without being limited to such the embodiment, the following embodiment may be adopted for example.

Specifically, in an embodiment, the mounting device may not include a pivotal part and may include a mounting part fixed in a vertical direction in advance. Namely, the mounting device may include a mounting part, an elevating part where the mounting part is located at an upper end of the elevating part, and a base part on which the elevating part is located. In this case, due to the fixing of the mounting part in the vertical direction in advance, an object to be mounted on the mounting part can be fixed in the vertical direction with a movement of the mounting part. As a result, it is possible to project the image from the projectable object to be mounted onto only the object to be projected, the object to be projected being arranged on the horizontal plane.

The mounting device according to an embodiment of the present invention has been hereinbefore described. The present invention is not limited to it. It will be readily appreciated by the skilled person that various modifications are possible without departing from the scope of the present invention.

It should be noted that the present invention as described above includes the following aspects:

The first aspect: A mounting device, comprising:
a mounting part, the mounting part serving to mount a projectable object to be mounted;
a pivotal part, the pivotal part being connected with the mounting part and allowing the mounting part to be pivoted;
an elevating part, the elevating part being connected with the pivotal part and allowing a height level of the mounting part to be changed; and
a base part, the base part serving to locate the elevating part,
wherein the pivotal part is configured to be pivotable in a horizontal direction or a vertical direction about an axis rotatably configured,
wherein the elevating part comprises a supporting portion, a fixed portion on the base part, a piston, and at least one coupling portion, the supporting portion serving to support the pivotal part, the piston connecting the supporting portion with the fixed portion, the coupling portion coupling the supporting portion with the fixed portion, and
wherein the coupling portion is configured to be capable of making a displacement of the coupling portion.
   The second aspect: The mounting device according to the first aspect, wherein the coupling portion is configured such that one of ends of the coupling portion is coupled with the supporting portion and other of ends of the coupling portion is coupled with the fixed portion.
   The third aspect: The mounting device according to the first or second aspect, wherein a downward displacement of the coupling portion is performed in accordance with a downward displacement of the supporting portion.
   The fourth aspect: The mounting device according to the first or second aspect, wherein an upward displacement of the coupling portion is performed in accordance with an upward displacement of the supporting portion.
   The fifth aspect: The mounting device according to any one of the first to fourth aspects, further comprising a handle part, the handle part being located to surround the object to be mounted.
   The sixth aspect: The mounting device according to any one of the first to fifth aspects, the base part is configured to be movable.

### INDUSTRIAL APPLICABILITY

The mounting device according to an embodiment of the present invention can be used to mount a projector, Particularly, an ultrashort focus projector.

### CROSS REFERENCE TO RELATED PATENT APPLICATION

The present application claims the right of priority of Japanese Patent Application No. 2016-110319 (filed on Jun. 29, 2016, the title of the invention: “MOUNTING DEVICE”), the disclosure of which is incorporated herein by reference.

### EXPLANATION OF REFERENCE NUMERALS

10 Mounting part
15 Connection part
20 Pivotal part
21 Receiving portion
21a Edge surface of receiving portion
22 Abutting portion
23 Axis rotatably configured
30 Elevating part
30a Upper end of elevating part
31 Fixed portion
31a Lower portion of fixed portion
31b Protrusion of fixed portion
31c Inner region of lower portion of fixed portion
32 Supporting portion
32a Upper end of supporting portion
32b Lower end of supporting portion
32c Inner side surface of supporting portion
33 Coupling portion
33a One of ends of coupling portion
33b Other of ends of coupling portion
40 Base part
41 wheel
50 Lever part
60 Piston member
61 Pipe
62 Cylinder
70 Angle changeable portion
80 Tube
90 Handle part
100 Mounting device
200 Object to be mounted
300 Ground

1. A mounting device, comprising:
a mounting part, the mounting part serving to mount a projectable object to be mounted;
a pivotal part, the pivotal part being connected with the mounting part and allowing the mounting part to be pivoted;
an elevating part, the elevating part being connected with the pivotal part and allowing a height level of the mounting part to be changed; and
a base part, the base part serving to locate the elevating part,
wherein the pivotal part is configured to be pivotable in a horizontal direction or a vertical direction about an axis rotatably configured,
wherein the elevating part comprises a supporting portion, a fixed portion on the base part, a piston, and at least one coupling portion, the supporting portion serving to support the pivotal part, the piston connecting the supporting portion with the fixed portion, the coupling portion coupling the supporting portion with the fixed portion, and
wherein the coupling portion is configured to be capable of making a displacement of the coupling portion.

2. The mounting device according to claim 1, wherein the coupling portion is configured such that one of ends of the coupling portion is coupled with the supporting portion and other of ends of the coupling portion is coupled with the fixed portion.

3. The mounting device according to claim 1, wherein a downward displacement of the coupling portion is performed in accordance with a downward displacement of the supporting portion.

4. The mounting device according to claim 1, wherein an upward displacement of the coupling portion is performed in accordance with an upward displacement of the supporting Portion.

5. The mounting device according to claim 1, further comprising a handle part, the handle part being located to surround the object to be mounted.

6. The mounting device according to claim 1, the base part is configured to be movable.
